(19) United States
(12) Patent Application Publication
(10) Pub. No.: US 2012/0103766 A1
(43) Pub. Date: May 3, 2012

(54) ON-LOAD TAP CHANGER WITH ENERGY STORAGE MECHANISM

(76) Inventors: Klaus Hoepfl, Maxhuette-Haidhof (DE); Gregor Wilhelm, Regensburg (DE); Silke Wrede, Zeitlarn (DE)

(21) Appl. No.: 13/380,684

(22) PCT Filed: Apr. 21, 2010
(86) PCT No.: PCT/EP2010/002429

§ 371 Date: Jan. 12, 2012

(30) Foreign Application Priority Data
Jul. 24, 2009 (DE) 10 2009 034 627.9

(51) Int. Cl. H01H 19/02

(52) U.S. Cl. 200/11 J

(57) ABSTRACT

The invention relates to an on-load tap changer having an energy storage device, by means of which an output shaft is rotatable in spurts. According to the invention, in addition to the actual energy storage spring or the actual energy storage springs, at least one further spring is provided, which absorbs/releases energy after the activation of the energy storage mechanism, whereby the torque curve can be optimised.

The invention relates to an on-load tap changer with a force store for conversion of the continuous rotational movement of a drive shaft into an abrupt, rapid rotational movement of a driven shaft.

Numerous force stores are already known which make possible abrupt rotational movement of the driven shaft in that one or more stressed force store springs are abruptly released. Such force store springs can be not only tension springs, but also compression springs. The principle is in that case always the same: a rotating drive shaft stresses the spring or the springs up to a maximum point and thereafter these abruptly relax and thereby move the driven shaft therewith. Such a force store is known from DE 10 2006 008 338. Obviously, in the case of the force stores of that kind—as a consequence also of the spring characteristic—the torque is greatest at the commencement of triggering of the springs stressed until then; it decreases until attainment of the end setting. However, in certain cases this predetermined course of torque, which is dependent on the spring characteristic as well as the respective kinematics, and the speed, which results therefrom, of the driven shaft is not desired. This particularly concerns cases in which a greater number of switching elements or other components of the on-load tap changer are to be actuated in succession in a quite specific sequence.

In such instances of use a force store is therefore desirable in which a selective adaptation of the course of the abrupt driven movement to the respective actual requirements is achieved.

It is already known from DE-AS 25 02 810 to provide for that purpose an auxiliary force store in the case of a force store of the kind cited in the introduction. Apart from the actual force store springs a further spring is then provided which on triggering of the force store is stressed by way of a toggle joint. In that case a deceleration of the triggered force store in the first part of the movement course is achieved by this additional spring being stressed, whereas toward the end of the course of movement, if the actual force store spring is already largely relaxed, the additional spring is similarly relaxed, whereby the spring forces summate. This known solution was conceived at the time in order to slow down the triggering of the force store specifically for the purpose of being able to switch an alternating current of 16⅔ Hz instead of the usual alternating current at a frequency of 50 Hz without the switchover process as a whole elapsing too rapidly. This known force store is, moreover, of mechanically complicated construction, particularly due to the roller guidance and additional toggle lever arrangement for actuation of the auxiliary force store springs. Moreover, it is exclusively provided for a force store in which a rotational movement of the drive shaft is initially converted into a longitudinal movement in which the force store springs are stressed and the rapid longitudinal movement after triggering thereof is converted back into a rotational movement of the driven shaft. The known solution is not suitable for direct conversion continuously into a rapid rotational movement.

The object of the invention is to indicate an on-load tap changer with a force store, wherein the force store comprises, apart from the actual force store spring or actual springs, further means which lead to selective adaptation of the rotational movement of the driven shaft.

This object is fulfilled by the invention.

A particular advantage of the invention is the simple construction thereof. Through an additional cam disk disposed in connection with the driven shaft a connecting part is deflected whereby—depending on the respective instantaneous position of the cam disk—an additional spring is stressed or relaxed. The energy taken up or delivered by the additional spring or additional springs decelerates or accelerates the rotational movement of the driven shaft selectively and appropriately to need, while the actual force store spring relaxes.

The invention will be explained in more detail by way of example in the following with reference to a drawing.

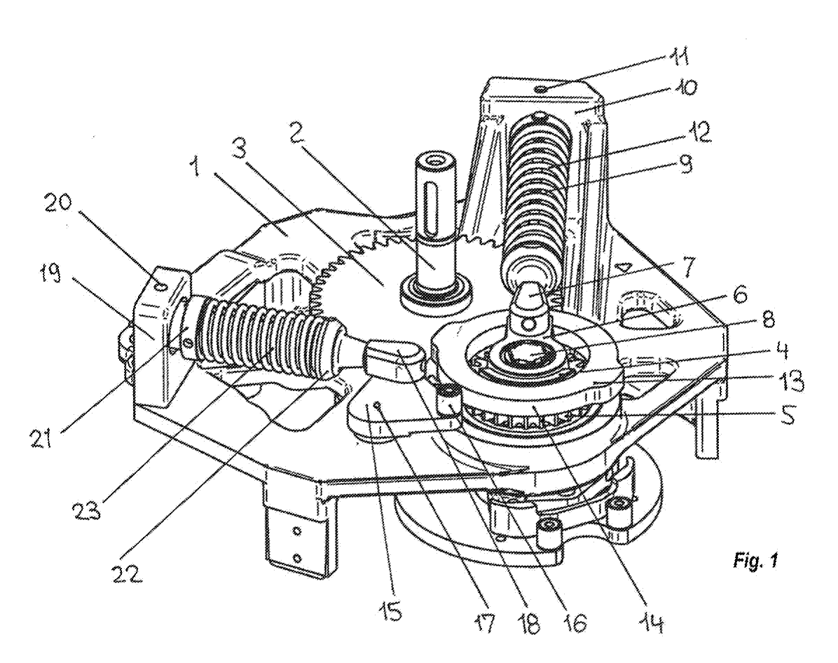

FIG. 1 shows a first on-load tap changer according to the invention with force store in a perspective schematic illustration,

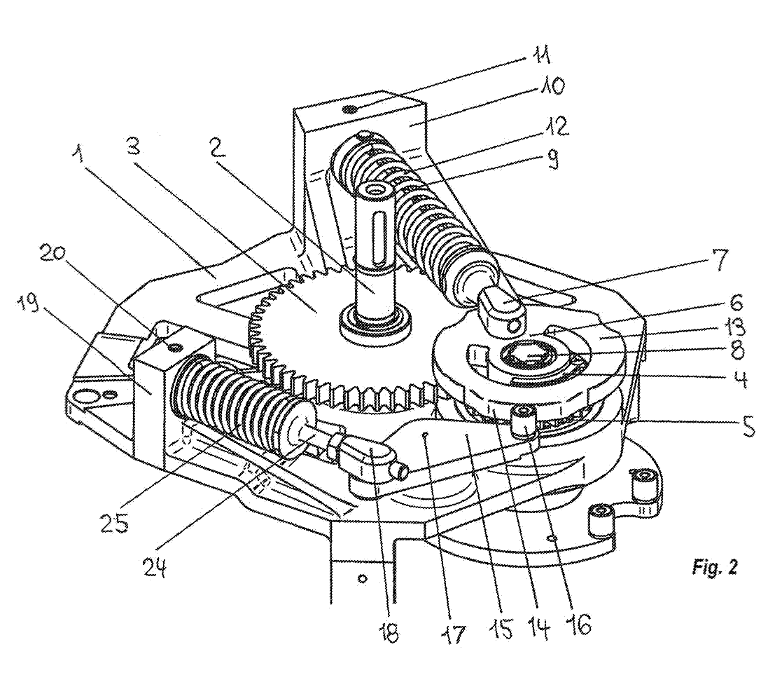

FIG. 2 shows a second form of embodiment of an on-load tap changer according to the invention and

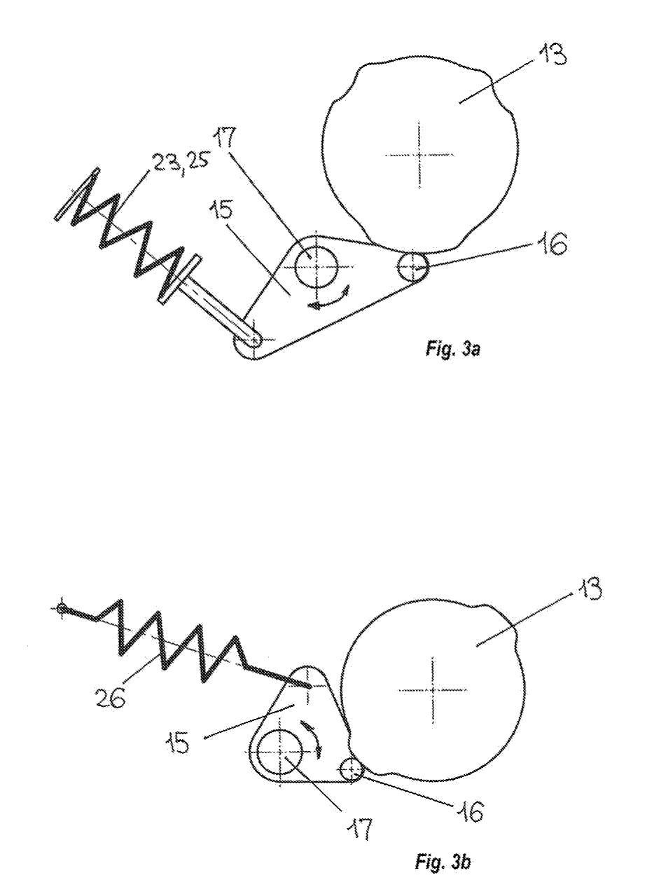

FIG. 3 shows schematic illustrations of different spring types within the scope of the invention.

The components designated by the references 1 to 12 are already known from DE 10 2006 008 338 B3 cited in the introduction, but for an understanding of the overall function are explained once again here.

A support plate 1 is shown in FIG. 1, on which the entire force store and the transmission arrangement of the on-load tap changer are arranged. Also shown is a drive shaft 2 which is connected with a gearwheel 3 and continuously drives this. The gearwheel 3 in turn drives a drive element 4 by way of the toothing 5 thereof. The drive element 4 has symmetrical abutments which correspond with a drive crank 6 and can set this in rotation. A pull rod head 7, on which a pull rod is disposed, is rotatably mounted at the top on the drive crank 6. The drive crank 6 is fastened on a driven shaft 8 which runs perpendicularly downwardly through the support plate 1. The components connected therewith for actuation of the contacts are not shown here. A spring tube 9 is provided around the pull rod. The spring tube 9 is articulated at one end with a bearing block 10; it is horizontally displaceable by means of a perpendicular bearing pin 11. One or more compression springs is or are provided concentrically around the spring tube 9 or also therein. Only a single compression spring 12 is illustrated here.

The functioning of the force store known up to now is as follows: At the start of each switching over, i.e. each actuation of the on-load tap changer, a motor drive rotates the gearwheel 3 by way of the drive shaft 2. This rotational movement is transmitted by way of the toothing 5 to the drive element 4. According to the rotational direction, which depends on whether the next load switchover is to taken place in the direction of ‘higher’ or ‘lower’, one of the symmetrical abutments of the drive element 4 comes into abutment with the drive crank 6 and rotates this with it. In that case the pull rod head 7 rotates therewith; the pull rod is deflected and the compression spring 12 is stressed. After one revolution of the drive crank the pull rod has reached its new end setting; the compression spring 12 is stressed to a maximum. After exceeding the dead center the rotational movement of the drive crank 6 and thus of the driven shaft 8 is led rapidly to a conclusion, since the compression spring 12 is abruptly relaxed. This rapid rotational movement ultimately leads to a rapid switching over between individual contacts in the on-load tap changer.

According to the invention a cam disk 13 having an end-face profile 14 is arranged on the drive crank 6 in fixed connection therewith. This profile departs, as seen from above, from a circular shape. It is freely selectable within wide limits and can also be of directionally- dependent different construction. In addition, a connecting part 15 is provided which has at one end thereof a roller 16 running on the end-face profile 14 of the cam disk 13. The connecting part 15 is pivotable about an axis 17 of rotation and carries at its other end, again to be rotatable, a further rod head 18 which in turn has a guide rod rotatably mounted in a further spring tube at its other end at a further bearing block 19 by means of a further bearing pin 20. Disposed at both ends of the guide rod are spring counter-bearings 21, 22 between which a further spring 23 is arranged. In addition, in this case one spring counter-bearing 22 is fixed whilst the other spring counter-bearing 21 is movable.

The operation of this auxiliary device is as follows: After passing the dead center the drive crank 6 and thus the driven shaft 8 begin to rapidly rotate, since, as explained, the compression spring 12 abruptly relaxes. The cam disk 13 also rotates together with the drive shaft 8. The roller 16 running on the profile 14 of the cam disk is thereby pivoted and, with it, the entire connecting part 15. The spring 23 is thereby additionally stressed or relaxed. It reduces or reinforces the energy of the compression spring 12 and thus brakes or accelerates the rotational movement of the cam disk 13 and thereby the driven shaft 8. On further rotation of the driven shaft 8 the roller 16 then moves into another position in which the spring 23 relaxes and its previously stored energy is now delivered in addition to the energy—which is now becoming smaller—of the compression spring 12. Overall, a rapid movement, which is adapted to the respective kinematic requirements, of the driven shaft 8 is thus achieved with maximally optimized torque.

FIG. 2 shows a further form of embodiment of the invention. In this regard, a connecting part 15 is again pivotable about an axis 16 of rotation and again carries the rod head 18, which here is fixedly connected with a spring counter-bearing 24. A spring 25 is arranged between this and the bearing block 19. In this form of embodiment the direction of movement of the spring 25 is thus reversed relative to the form of embodiment illustrated in FIG. 1. The spring 25 is fixed to the bearing block 19 and is stressed by the spring counter-bearing 24. The respective springs 23 and 25 explained in FIGS. 1 and 2 are accordingly constructed as compression springs.

It is also possible within the scope of the invention to use tension springs in their place. This is schematically illustrated in FIG. 3. Different kinds of springs can be used solely by the physical arrangement of the axis 17 of rotation of the connecting part 15 and the position of the roller 17 which runs of the profile 14 of the cam disk 13. FIG. 3a shows a tension spring 26 which can be deflected. FIG. 3b shows a compression spring 23, 25 which can be compressed. Also conceivable within the scope of the invention are respective concentric arrangements of, in each instance, two or also more such springs 23, 25 or 26.

Moreover, a form of embodiment as a linear guide is also possible within the scope of the invention.

Regardless of the actual form of construction of the force store the essence of the invention consists generally in that a driven shaft 8 is abruptly rotated by a force store spring after triggering thereof and fastened to this driven shaft 7 is a cam disk 13 with an end-face profile 14 by which a further spring 23, 25 or 26 is relaxed or stressed appropriately to requirements and thus the speed of the rotational movement is selectively influenced by delivery or take-up of energy. At the end of the abrupt movement excess movement energy can be absorbed by stressing the further spring 23, 25 or 26 and a smooth braking can thereby be achieved in advantageous manner. As already explained, the take-up of energy is possible through either the expansion of a tension spring 26 or the compression of a compression spring 23, 25.

1. An on-load tap changer with a force store, wherein
the force store comprises a drive element that can be continuously drawn up by a drive shaft and a driven part,
the drive element is disposed in mechanical connection with at least one force store spring that can be stressed when the drive element is drawn up,
the driven element can be triggered after the stressing of the at least one force store spring and abruptly rotates a driven shaft,
a cam disk with an end-face profile departing from circular shape is fastened to the driven shaft,
at least one further spring is provided,
the at least one further spring is fixed at one end thereof and articulated at the other end other thereof to a connecting part pivotable about a fulcrum,
the connecting part carries a rod head having a guide rod fastened at the other end thereof to a bearing block,
spring counter-bearings between which the at least one further spring is arranged are disposed on both sides of the guide rod, and
the connecting part has at the free end thereof a roller that runs on the profile in such a manner that on rotation of the cam disk the at least one further spring can be stressed or relaxed in dependence on the profile.

2-4. (canceled)
